(19) United States
(12) Patent Application Publication
(10) Pub. No.: US 2008/0219282 A1
(43) Pub. Date: Sep. 11, 2008

(54) CUSTOMER TERMINATION POINT IN THE SUBSCRIBER PREMISES OF A TELECOMMUNICATION AND/OR DATA LINK AND METHOD FOR CHANGING PROVIDERS

(75) Inventors: Jorg Adomeit, Berlin (DE); Jorg Franzke, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/044,256

(22) Filed: Mar. 7, 2008

(30) Foreign Application Priority Data
Mar. 9, 2007 (DE) 10 2007 011 683.9

(51) Int. Cl. H04L 12/56

(52) U.S. Cl. 370/420

(57) ABSTRACT

The invention relates to a customer termination point (1) in the subscriber premises of a telecommunication and/or data link, comprising at least one device for connecting subscriber lines, wherein the customer termination point (1) comprises at least two devices for subscriber lines of at least two providers (a-c), wherein in each case one subscriber line of the various providers (a-c) is connected to a common switching element (6) having at least two inputs (7a-c), wherein an output (7d) of the switching element (6) is connected to a subscriber connection (10) or a device for connecting subscriber lines, wherein each switching element (6) has at least one control input (S) by means of which one of the at least two inputs (7a-c) is switched through to the output (7d) of the switching element, and a method for changing providers.

The invention relates to a customer termination point in the subscriber premises of a telecommunication and/or data link and to a method for changing providers.

At the customer termination point (CTP), the underground cable from the exchange ends as a subscriber line. The customer termination point forms the termination of the access network and represents the interface to the in-house or subscriber drop network. If a subscriber then wishes to change his provider, the associated line is then patched from the main distribution frame to a collocation distributor (interchange distributor) of the new provider in a switching office, and from there back to the subscriber side of a main distribution frame. From there, the line is then run in the form of a cable to cable distribution boxes and from there finally as a subscriber line to the customer termination point. The method described is relatively complex since the main distribution frames of the network operator or original provider and the collocation distributors of the new provider are frequently not arranged in immediate spatial vicinity. The generic term collocation describes the joint use of established physical and electrical interfaces of two network operators within a common room. On the site of the main distribution frame of the corresponding service area, line paths are terminated at so-called interchange distributors and are there provided for the new network operators (providers). These can then connect their switching offices via separate line paths to the interchange distributor in the collocation room.

The invention is therefore based on the technical problem of creating a customer termination point in the subscriber premises of a telecommunication and/or data link and a method for changing providers by means of which the process of changing providers is simplified.

In this respect, the customer termination point in the subscriber premises of a telecommunication and/or data link comprises at least two devices for connecting subscriber lines of at least two providers, wherein in each case one subscriber line of the various providers is connected to a common switching element having at least two inputs, wherein one output of the switching element is connected to a subscriber connection or a device for connecting subscriber lines, wherein each switching element has at least one control input by means of which one of the at least two inputs is switched through to the output of the switching element. To change the provider, a switching command is generated by means of which the output of the switching element associated with the subscriber is connected to the input of the required provider. As a result, the change occurs simply at the customer termination point and no manual repatching is necessary. Various variants are thereby possible regarding who triggers or generates the change-over command. Thus, it can be initiated by the switching office, the subscriber or a provider. This only requires that reliable access to the switching elements is guaranteed, for example by means of coding. The switching elements can be accessed either by line or via an air interface. Furthermore, the customer termination point can be arranged for copper wires and/or optical waveguides. Each switching element preferably has as many inputs as there are possible providers. Furthermore, the switching element preferably has a position in which no input is switched to the output.

In a preferred embodiment, the control inputs of the switching elements are connected to a controller wherein the switching elements and the controller are also preferably arranged on a common circuit board and/or in a common housing.

In a further preferred embodiment, the switching elements are arranged to be cascaded.

In a further preferred embodiment, the devices for connecting the subscriber lines and/or the device for connecting subscriber lines are arranged as connection blocks for copper pairs.

In a further preferred embodiment, the switching elements are arranged as relays.

In the text which follows, the invention will be explained in greater detail with reference to a preferred exemplary embodiment. In the figures:

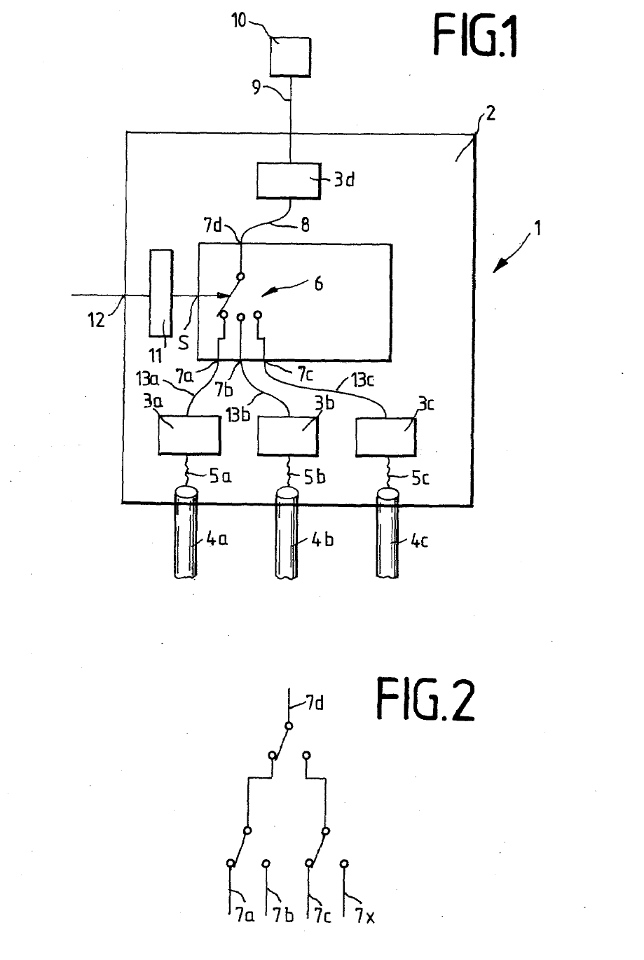

FIG. 1 shows a schematic block diagram of a customer termination point, and

FIG. 2 shows a schematic representation of a cascaded switching element.

The customer termination point 1 comprises a housing 2 in which connection blocks 3a-c are arranged. In this arrangement, the connection blocks 3a are allocated to a provider a, the connection blocks 3b are allocated to a provider b and the connection blocks 3c are allocated to a provider c. The providers a-c in each case run underground cables 4a-c to the customer termination point 1 from where the underground cables 4a-c are then connected or terminated as a multiplicity of pairs 5a-c on the connection blocks 3a-c. For reasons of clarity, only one pair 5a-c is in each case shown in FIG. 1. In this arrangement selected the size or number of connection blocks 3a-c is in such a manner that as many pairs 5a-c can be terminated as there are subscribers allocated to the customer termination point 1. In this arrangement, the pairs 5a-c represent the subscriber lines. Furthermore, the customer termination point 1 comprises a number of switching elements 6, the number of switching elements 6 corresponding to the number of subscribers. The switching elements 6 comprise a number of inputs 7a-c which, simplified, corresponds to the number of providers a-c. Due to the fact that pairs 5a-c are switched, the number of inputs is actually twice as large since the switching elements 6 must implement the circuit shown for each wire of a pair 5a-c. In addition, the switching element 6 has an output 7d, each switching element 6 actually having two outputs 7d even here because of the pairs. The output 7d is either connected to an input 7a-c or open, i.e. not connected to any input 7a-c in this arrangement.

The output 7d is then connected via a pair 8 to a connection block 3d which is used for terminating subscriber lines 9 which are connected to subscriber connections 10 (for example a telephone socket). The switching element 6 has at least one control input S which is driven by a controller 11. The controller 11 also has an interface 12 for receiving control information and, if necessary, sending status information. The pairs 5a-c are then connected via patching pairs 13a-c to the inputs 7a-c of the switching elements 6. Changing from a provider a to another provider b or c is then carried out by a control command of the controller 11 at the control input S so that the output 7d is connected to the input 7b or 7c.

A preferred application of the invention is changing providers for broadband services. To enable the providers a-c to check the desire for change by a subscriber, the provider a-c can interrogate the status of the switching elements 6, this preferably being restricted as follows. Thus, provider a can interrogate which subscribers are connected to his pairs 5a and which subscribers are not connected with any provider. If provider a then receives an order for changing by a subscriber who already had another provider (e.g. b), provider b must first switch his pair away from output 7d. It is only then that provider a can drive the switching element 6 and connect the output 7d to the input 7a. However, many other concepts are also conceivable.

FIG. 2 shows a cascaded switching element 6. Inputs 7a, 7b are here allocated to an output 7a, 7b and inputs 7c and 7x are here allocated to an output 7c,x, the two outputs 7a,b, 7c,x forming the inputs of a further switch with the output 7d. Such cascading is advantageous particularly with a very large number of providers a-c. However, more switching commands must then be correspondingly generated by the controller 11, at least two in the example shown.

### LIST OF REFERENCE DESIGNATIONS

1 Customer termination point
2 Housing
3a-c Connection blocks
4a-c Underground cables
5a-c Pairs
6 Switching element
7a-c,x Inputs
7a,b Output
7c,x Output
7d Output
8 Pair
9 Subscriber lines
10 Subscriber connections
11 Controller
12 Interface
13a-c Patching pairs
a-c Providers
S Control input

1. A customer termination point in the subscriber premises of a telecommunication and/or data link, comprising at least one device for connecting subscriber lines, wherein the customer termination point comprises at least two devices for subscriber lines of at least two providers, wherein in each case one subscriber line of the various providers is connected to a common switching element having at least two inputs, wherein an output of the switching element is connected to a subscriber connection or a device for connecting subscriber lines, wherein each switching element has at least one control input by means of which one of the at least two inputs is switched through to the output of the switching element.

2. The customer termination point as claimed in claim 1, wherein the control inputs of the switching elements are connected to a controller.

3. The customer termination point as claimed in claim 2, wherein the controller and the switching elements are arranged on a common circuit board and/or in a common housing.

4. The customer termination point as claimed in claim 1, wherein the switching elements are arranged to be cascaded.

5. The customer termination point as claimed in claim 1, wherein the device for connecting the subscriber lines and/or the device for connecting subscriber lines are arranged as connection blocks for copper pairs.

6. The customer termination point as claimed in claim 1, wherein the switching elements are arranged as relays.

7. A method for changing providers by means of a customer termination point as claimed in claim 1, wherein a switching command is generated by means of which the output of the switching element allocated to the subscriber is connected to the input of the required provider.

8. The method as claimed in claim 7, wherein the switching command is generated by the subscriber, the switching office or the provider.
